(19) United States
(12) Patent Application Publication
(10) Pub. No.: US 2005/0179869 A1
(43) Pub. Date: Aug. 18, 2005

(54) Method and apparatus for minimization of unwanted light in optical and image projection systems

(76) Inventors: Dong-Soo Shin, Petaluma, CA (US); Ruipeng Sun, Santa Rosa, CA (US); Michael Sungchun Jin, Petaluma, CA (US)

Correspondence Address: SIDLEY AUSTIN BROWN & WOOD LLP (LAIP GROUP), 555 W. FIFTH ST., SUITE 4000, LOS ANGELES, CA, 90013, US

(21) Appl. No.: 11/023,791

(22) Filed: Dec. 28, 2004

Related U.S. Application Data
(60) Provisional application No. 60/533,163, filed on Dec. 29, 2003.

(51) Int. Cl. G03B 21/14

(52) U.S. Cl. 353/20; 353/97

(57) ABSTRACT

A method and apparatus for enhancing performance of a projection system by blocking incident angle light rays without increasing the F-number of the system includes a skew filter having a shaped aperture. The skew filter blocks a substantial portion of the skew light rays while allowing other light rays to pass through the projection system. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or the meaning of the claims.

This is a non-provisional application claiming priority of Provisional Patent Application No. 60/533,163 filed on Dec. 29, 2003, which is hereby incorporated by reference in its entirety as if fully set forth herein.

### FIELD OF THE INVENTION

The present invention generally relates to performance enhancement in optical, image projection and communications systems. Specifically, the present invention relates to projection displays that incorporate polarized light sources and modulate the throughput of incident light.

### BACKGROUND OF THE INVENTION

In existing optical systems and other applications involving processing light rays, contrast and corner color uniformity limitations exist due to light rays that are incident to a polarizing beam splitter (PBS) at skew angles. Contrast performance of polarizing beam splitter (PBS)-based projection systems is limited by the angular performance of the PBS components. A typical PBS includes right-angle prisms that have multi-layer stacks coated on the surfaces corresponding to the hypotenuse of the right-angles of the adjoining prisms. The combination of right angle prisms and multi-layer stacks are designed so that at a 45° incidence angle to the adjoining surface, the incident beam will satisfy the Brewster's angle condition for the p-polarization component of the incident beam such that most of the p-polarization component is transmitted while the s-polarization component of the incident beam is rejected. This occurs because the spectral width of rejection bands for a multi-layer stack is different for s- and p-components of an incident beam. However, for a converging or diverging beam, the problem of depolarization, or the transmission and rejection of unwanted light, occurs due to the fact that even if the incident beam is purely polarized with respect to the incident plane of the PBS layer, the non-collimated nature of the incident light results in components which have propagation vectors that are not orthogonal to either of the p- or s-planes of the PBS layer. The result is a rotationally asymmetric transmission contrast ratio.

These skew rays therefore degrade the contrast ratio by depolarizing the incident beam, which then leaks through other polarizing and analyzing elements in the projection system. Degradation in contrast limits the ability to display colors in a resulting image.

One existing method of addressing these contrast and color corner uniformity limitations includes increasing an F-number of the optical system. Increasing the F-number blocks the incident-angle rays, resulting in increased contrast but also reduced light throughput. As the amount of light entering the optical system is reduced, the contrast is reduced, making the resulting image less and less bright.

### SUMMARY OF THE INVENTION

The present invention provides a method and apparatus for enhancing performance of a projection system by blocking incident angle light rays without increasing the F-number of the system. In one embodiment of the present invention, a method of reducing leakage of unwanted polarization in a projection apparatus comprises introducing a light source to the projection apparatus for producing a plurality of light rays, the plurality of light rays including orthogonally-polarized light rays and skew light rays having multiple polarization components, and preventing the transmission of a substantial portion of the skew light rays to a polarization apparatus by applying a skew filter at a filter position in the projection apparatus, the skew filter including an aperture with a shape configured to allow the orthogonally-polarized rays to pass into the polarization apparatus and to block the skew light rays from entering the polarization apparatus by following a constant contrast curve of a polarizing beam splitter for a cone of light incident on to the polarizing beam splitter. In another embodiment of the present invention, a method of increasing contrast in an image processing apparatus without increasing the F-number comprises rejecting a substantial portion of a plurality of skew rays introduced by a light source by applying a skew filter at a filter position in the image processing apparatus, the light source introducing a plurality of orthogonally-polarized rays and a plurality of skew rays having multiple polarization components, and processing the plurality of orthogonal rays in a polarization apparatus, the polarization apparatus including a plurality of polarizing beam filters for transmitting a plurality of orthogonal rays, wherein the skew filter includes an aperture having a shape configured to follow a constant contrast curve of at least one polarizing beam splitter in the plurality of polarizing beam splitters for a cone of light incident thereto.

In another embodiment of the present invention, an image projection apparatus comprises a light source, the light source producing a plurality of light rays including skew light rays and orthogonally polarized light rays, a polarization apparatus including at least one polarizing beam splitter, a plurality of lenses through which the plurality of light rays passes to the polarization apparatus, and a skew filter positioned at a filter position and having a shaped aperture for blocking the passage of a substantial portion of the skew light rays to the polarization apparatus while allowing a substantial portion of the orthogonally polarized rays to pass through to the polarization apparatus, wherein the shaped aperture of the skew filter has a shape which follows a constant contrast curve of the at least one polarizing beam splitter for a cone of light incident to the at least one polarizing beam splitter. Another embodiment of the present invention includes a contrast enhancement apparatus in an image projection system comprising an angular light rejection plate configured to block a substantial portion of angular light from entering a polarization apparatus and to allow orthogonally polarized light to enter the polarization apparatus, the polarization apparatus having at least one polarizing beam splitter, the at least one polarization beam splitter having a right angle prism having multi-layer filter stacks, the polarization apparatus configured to process the orthogonally polarized light to produce an image having enhanced contrast.

In yet another embodiment of the present invention, a method of increasing contrast in an image processing apparatus without increasing the F-number comprises means for introducing a plurality of light rays to a polarization apparatus, the plurality of light rays including skew light rays which enter the polarization apparatus at incident angles and orthogonally polarized light rays which enter the polarization apparatus at orthogonal angles, means for rejecting a substantial portion of the skew light rays without reducing the F-number of the image processing apparatus, and means for processing a substantial portion of the orthogonally polarized light rays in the polarization apparatus, the polarization apparatus including a plurality of polarizing beam splitters for transmitting the orthogonally polarized light rays.

The foregoing and other aspects of the present invention will be apparent from the following detailed description of the embodiments, which makes reference to the several figures of the drawings as listed below.

### BRIEF DESCRIPTION OF THE DRAWINGS

FIG. 1 is a top view depicting a projection apparatus according to the present invention;

FIG. 2(a) is a constant contrast curve of a cone of light rays emerging from a single PBS;

FIGS. 2(b) and 2(c) are side views of a skew filter according to one embodiment of the present invention;

FIG. 3(a) is a constant contrast curve of a cone of light rays emerging from two PBSs in sequence with planes of the PBS layer orthogonal to each other;

FIGS. 3(b) and 3(c) are side views of a skew filter according to another embodiment of the present invention;

FIG. 4 is a side view of a skew filter according to another embodiment of the present invention;

FIG. 5 is a close-up view of a color management system according to one embodiment of the present invention;

FIG. 6 is a frequency representation of s and p polarization components of light rays;

FIG. 7 is a top view of a projection apparatus according to the present invention;

FIG. 8(a) is a perspective view depicting a cone of rays incident on a PBS in a projection apparatus that leads to depolarization according to the present invention; and

FIG. 8(b) is a side view depicting a cone of rays emerging from a PBS.

### DETAILED DESCRIPTION OF THE EMBODIMENTS

In the following description of the present invention reference is made to the accompanying drawings which form a part thereof, and in which is shown, by way of illustration, exemplary embodiments illustrating the principles of the present invention and how it may be practiced. It is to be understood that other embodiments may be utilized to practice the present invention and structural and functional changes may be made thereto without departing from the scope of the present invention.

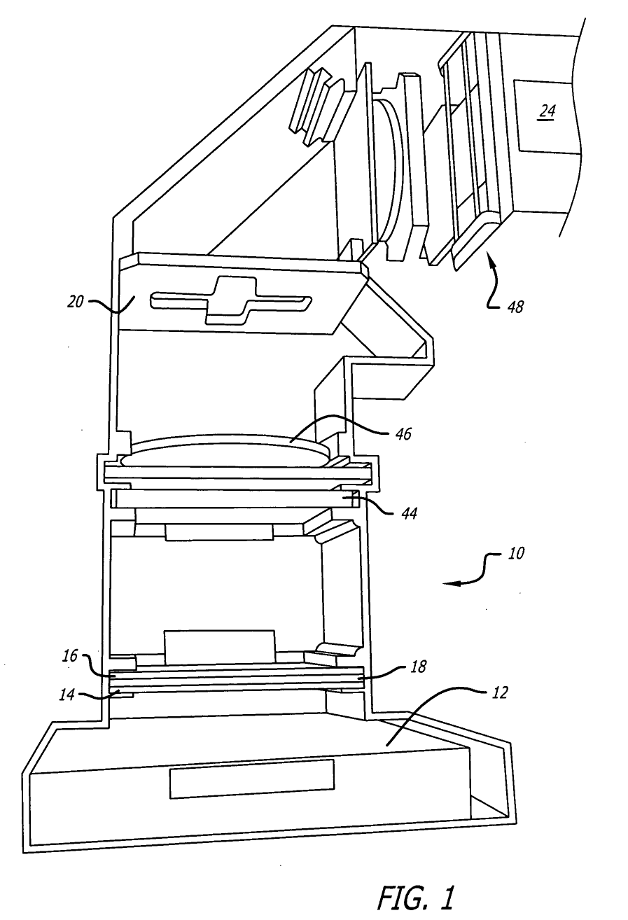

FIG. 1 is a top view of a projection apparatus 10 according to one embodiment of the present invention. The projection apparatus 10 includes a light source 12, a first fly's eye integrator lens 14, a second fly's eye integrator lens 16, a UV/IR filter 18, and a skew filter 20. The projection apparatus 10 also includes a first relay lens 44 and a second relay lens 46.

The projection apparatus 10 also includes a polarization apparatus 48. The polarization apparatus 48 modulates light from the light source 12 and includes a color management system 22 that includes a polarizing beam splitter 24. The polarizing beam splitter 24 includes a right angle prism 26, the right angle prism 26 having a plurality of multi-layer filter stacks 28. A right angle prism 26 may be substantially composed of glass, and a multi-layer filter stack 28 may have a coating on at least one surface. In one embodiment of the present invention, the color management system 22 includes a plurality of polarizing beam splitters 24, each including a right angle prism 26 and a plurality of multi-layer stacks 28. In one embodiment of the present invention, the UV/IR filter 18 is located between the first fly's eye integrator lens 14 and the light source 12, and the second relay lens 46 is located between the first relay lens 44 and a first polarizing beam splitter 24 in the plurality of polarizing beam splitters 24.

The light source 12 of the projection apparatus 10 produces light rays 32. The light rays 32 include orthogonally-polarized light rays 34 and skew light rays 36. The orthogonally-polarized light rays 34 and the skew light rays 36 each include s-polarization components and p-polarization components. The s-polarization and p-polarization components of the skew light rays 36 are at least partially incident to an optical plane. The orthogonally-polarized light rays 34 enter the polarizing beam splitter 24 at orthogonal angles, such that the p- and s-polarization components are properly modulated by the polarizing beam splitter 24 as explained herein. The skew light rays 36, however, enter the polarizing beam splitter 24 at angles incident to the internal components of the polarizing beam splitter 24, such that the p and s polarization components are not properly modulated, resulting in leakage of the p- and s-polarization components, and color degradation in a resulting image. Therefore, the presence of the skew light rays 36 results in leakage of unwanted polarization in the projection apparatus 10.

The projection apparatus 10 of the present invention may be utilized in any type of communications system or image processing system. For example, optical systems for use in applications including, but not limited to, high-definition television, may include a projection apparatus 10 as described herein. The present invention can also be used to improve other limitations in optical systems that suffer from effects of skew rays. For example, the performance of optical systems utilizing dichroic mirrors can also be improved by performing analysis of off-axis skew ray response to arrive at optimal aperture sizes and optimal filter position location in the illumination optics electronics. Additionally, any image projection or processing apparatus or system may utilize a projection apparatus 10 having the features and characteristics described herein. Where the projection apparatus 10 is employed in an image processing apparatus or system, preventing the transmission of the skew light rays 36 therefore increases a contrast of a resulting image in the image processing system. Further applications include satellite communications systems, and other communications systems in which incident waves or signals must be filtered or blocked to improve signal transmission quality and to improve the resulting output quality.

A typical contrast performance of polarizing beam splitter-based projection systems is limited by the angular performance of the right-angle prisms 26 that have multi-layer stacks 28. The combination of a glass prism 26 and multi-layer filter stacks 28 are typically designed so that at a 45° incidence angle to the adjoining surface, the incident light ray will satisfy the Brewster's angle condition for the p-polarization component, such that most of the p-polarization component of the incident light ray is passed while the s-polarization component of the incident light ray is rejected. Therefore, the polarizing beam splitter 24 transmits, or allows to pass, p-polarization components, and reflects, or rejects, s-polarization components. This occurs because the spectral width of rejection bands for a multi-layer stack 28 is different for s and p components of an incident beam. However, for a converging or diverging beam, the problem of de-polarization, or the transmission and rejection of unwanted light, occurs due to the fact that even if the incident beam is purely polarized with respect to the incident plane of the polarizing beam splitter layer, the non-collimated nature of the incident light results in components which have propagation vectors that are not orthogonal to either of the p- or s-planes of the polarizing beam splitter layer.

The projection apparatus 10 also includes a plurality of micro-displays 30. The plurality of micro-displays 30 are commonly known in the existing art for use in optical and image projection systems for transferring light into images on a screen or other apparatus.

The skew filter 20 includes a shaped aperture 38. The shaped aperture 38 of the skew filter 20 has a shape which follows a constant contrast curve 50 of the polarizing beam splitter 24 for a cone of light incident on to the polarizing beam splitter 24. The shaped aperture 38 is a hole 40 in the skew filter 20 shaped to allow a substantial portion of the orthogonally-polarized light rays 34 to pass through the projection apparatus 10 while at the same time rejecting a substantial portion of the skew light rays 36 from entering the projection apparatus 10. A variety of shapes may be utilized with the present invention to follow a constant contrast curve 50 of the polarizing beam splitter 24 for a cone of light incident on to the polarizing beam splitter 24, as described in detail herein, and depending on the configuration of the color management system 22. In image processing applications including color management systems, the shape of the shaped aperture 38 may be modified to further optimize the overall performance due to different primary colors as well as other polarization control components in the color management system 22. The shaped aperture 38 is generally configured to lie in the middle of the skew filter 20, but as will be seen below, any number of shapes, sizes and locations of the shaped aperture 38 can be utilized with the present invention.

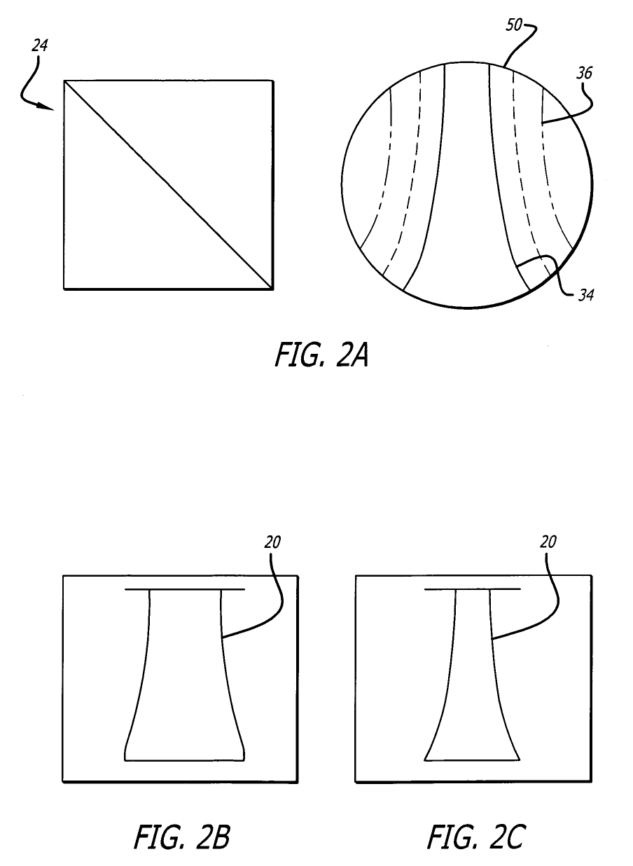

FIG. 2 includes side views (b) and (c) of two possible shaped aperture 38 shapes of a skew filter 20 according to one embodiment of the present invention in which the color management system 22 includes one polarizing beam splitter 24. FIG. 2(a) shows a constant contrast curve 50 for light rays modulated by a color management system 22 having one polarizing beam splitter 24. In FIG. 2, the shaped aperture 38 of the skew filter 20 may be shaped as shown in (b) or (c). The shapes shown in (b) and (c) are optimally configured to allow a substantial portion of orthogonally-polarized light rays 34 to enter the color management system 22 having one polarizing beam splitter 24 while blocking the skew light rays 36. The solid lines inside (a) represent the orthogonally-polarized light rays 34 while the dotted lines represent the skew light rays 36.

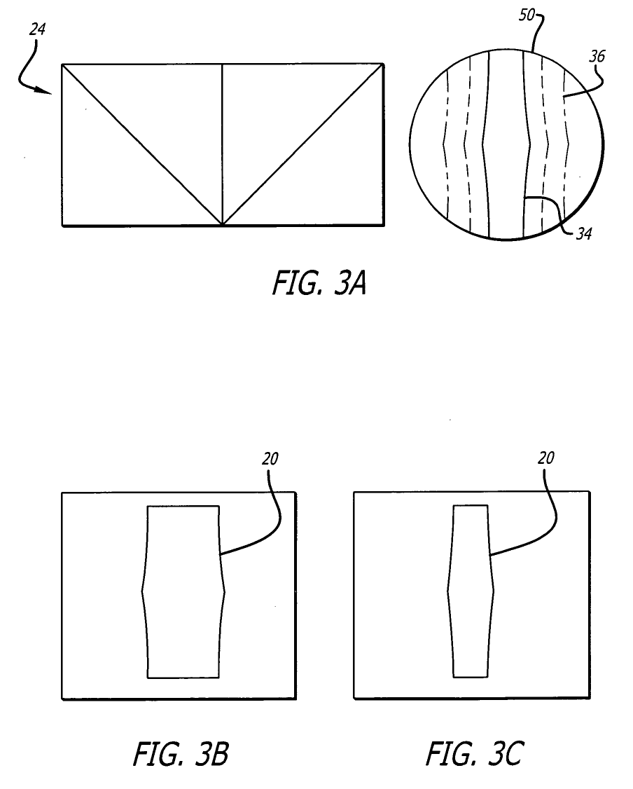

FIG. 3 includes side views (b) and (c) of two possible shaped aperture 38 shapes of a skew filter 20 according to another embodiment of the present invention in which the color management system 22 includes two polarizing beam splitters 24. FIG. 3 (a) shows a constant contrast curve 50 for light rays modulated by a color management system 22 having two polarizing beam splitters 24. In FIG. 3, the shaped aperture 38 of the skew filter 20 may be shaped as shown in (b) or (c). The shapes shown in (b) and (c) are optimally configured to allow a substantial portion of orthogonally-polarized light rays 34 to enter the color management system 22 having two polarizing beam splitters 24 while blocking the skew light rays 36. The solid lines inside (a) represent the orthogonally-polarized light rays 34 while the dotted lines represent the skew light rays 36.

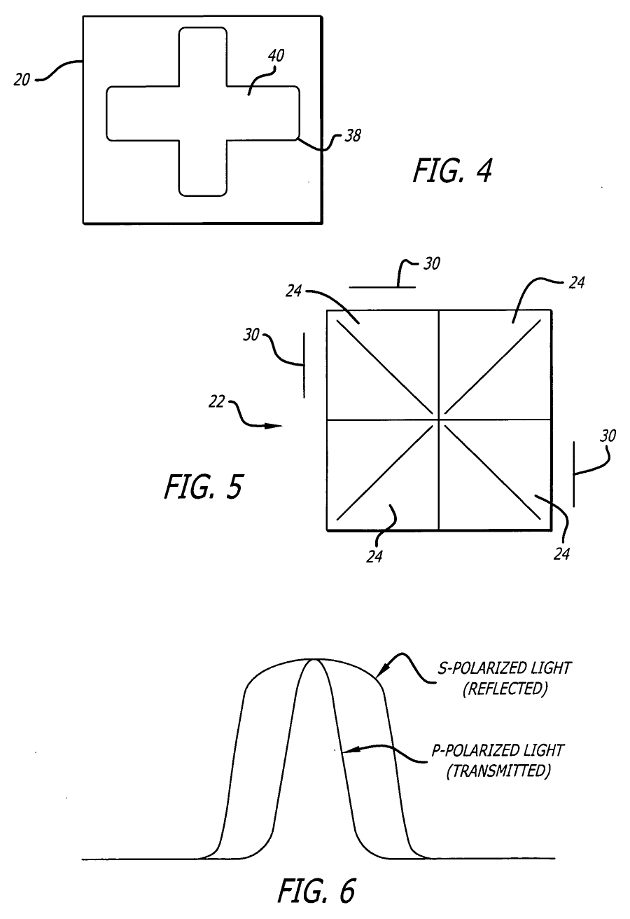

FIG. 4 is a side view of a skew filter 20 having a shaped aperture 38 according to another embodiment of the present invention to maximize overall performance in a color management system 22 having four or more polarizing beam splitters 24. In this embodiment, the shaped aperture 38 is substantially cross-shaped to block a substantial portion of the skew light rays while allowing passage of the orthogonally-polarized light rays 34.

In FIGS. 1-4, the skew filter 20 is a device made of a material sufficient to block light rays 32 from passing through the device, such as a metal. The device itself may be a plate or other solid instrument that can be inserted, fixably positioned, and removed from a projection apparatus 10. In one embodiment, the skew filter 20 may be substantially square in shape. It is to be understood, however, that the skew filter 20 may comprise any shape and material suitable for performing the present invention. The shaped aperture 38 of the skew filter 20 may be a hole 40 through which a desired amount of light may pass. In all embodiments, the shaped aperture 38 is optimally configured to allow passage of a desired amount of light. Use of a shaped aperture 38 as described in FIGS. 1-4 allows a projection apparatus 10 to utilize a greater amount of overall light rays 32 than by increasing an F-number of the optical system in the projection apparatus 10. Increasing an F-number restricts the passage of light rays 32 in a uniform fashion without regard to the type of light ray 32 blocked, thereby reducing the color clarity in a resulting image. By utilizing a shaped aperture 38 as in FIGS. 1-4, specific light rays 32 can be blocked to maximize the color and clarity of a resulting image by minimizing the passage of unwanted, or incident light rays 32. Therefore, the present invention provides a method and apparatus for increasing and enhancing contrast in an image processing apparatus without increasing the F-number.

The skew filter 20 of the present invention may be placed at a filter position 42. The filter position 42 is any position in the projection apparatus 10 at which a substantial portion of the skew light rays 36 are spatially located. The filter position 42 may also be any position where a substantial portion of the skew light rays 36 are blocked and a substantial portion of the orthogonally-polarized light rays 34 are allowed to pass. In one embodiment, the filter position 42 is located between the first relay lens 44 and the second relay lens 46. In another embodiment, the filter position 42 is located between the second relay lens 46 and the polarizing beam splitter 24. In embodiments with a plurality of polarizing beam splitters 24, the filter position 42 is located between the second relay lens 46 and first polarizing beam splitter 24 in the plurality of polarizing beam splitters 24.

Another embodiment of the present invention may be a “soft” aperture that has a predetermined transmission profile and shape that is optimized for a desired illumination profile at the object and to give the target contrast enhancement. Such an aperture 38 can be made, for example, by spatially varying the thickness of thin film absorbing material following the well-known relationship,
T(x, y)=exp[α·d(x, y)],
where T(x, y) is the spatial transmission profile of the aperture, α is the absorption coefficient and d(x, y) is the film thickness profile.

FIG. 5 is a close-up view of a color management system according to one embodiment of the present invention. FIG. 5 shows a color management system 22 including four polarizing beam splitters 22 and a plurality of micro-displays 30. The light rays 32 enter the color management system 22 and are modulated by the polarizing beam splitters 24 and then transmitted through the micro-displays 30. FIG. 6 is a frequency representation of s and p polarization components of light rays. As shown in FIG. 6, s-polarization components of light rays 32 have a broader frequency range than p-polarization components. A substantial portion of the s-polarization components are reflected, or rejected, by the polarizing beam splitters 24 of the color management system 22, while a substantial portion of the p-polarization components are transmitted by the polarizing beam splitters 24 of the color management system 22.

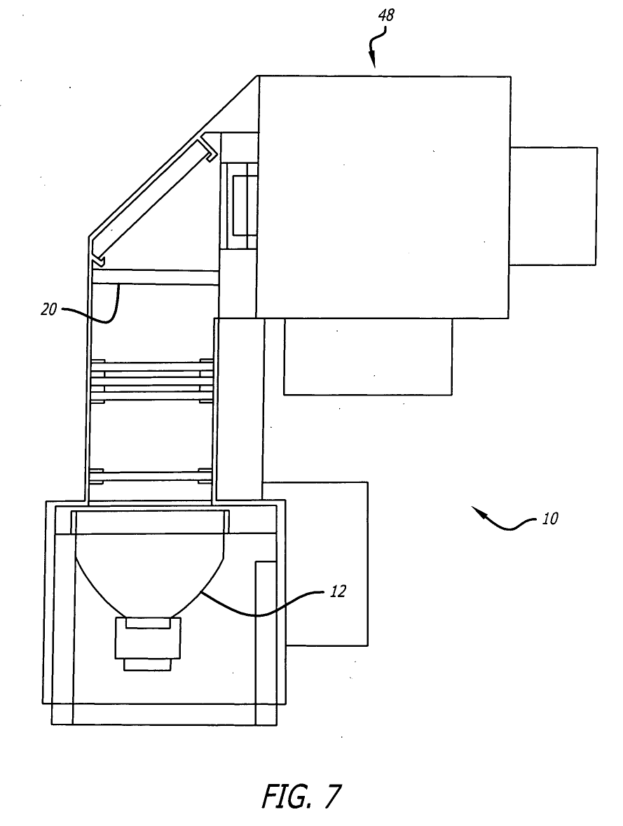

FIG. 7 is a design drawing of another top view of a projection apparatus 10 according to the present invention. FIG. 7 shows the projection apparatus 10 and the positioning of the skew filter 20 therein in one embodiment of the present invention.

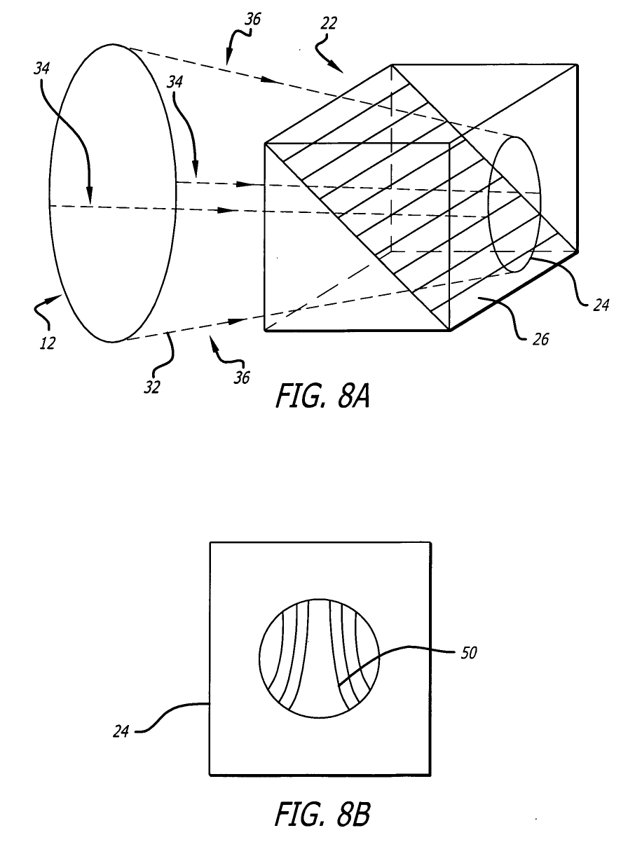

FIG. 8(a) is a perspective view depicting a cone of light rays 32 incident on a polarizing beam splitter 24 in a projection apparatus 10 that leads to depolarization according to the present invention. In FIG. 8(a), a cone of light rays 32 is shown projecting into a color management system 22. The color management system 22 includes a right angle prism 26 of a polarizing beam splitter 24 layer which processes the cone of light rays 32 and produces the light rays 32 exiting the polarizing beam splitter 24. FIG. 8(b) is cross-section of the constant contrast curves 50 produced by the polarizing beam splitter 24. FIG. 8(b) shows the cone of light rays 32 emerging from the polarizing beam splitter 24. FIG. 8(b) also depicts higher constant contour curves 50 located in the center of the cone of lights rays 32 emerging from the polarizing beam splitter 24.

It is to be understood that other embodiments may be utilized and structural and functional changes may be made without departing from the scope of the present invention. The foregoing descriptions of embodiments of the invention have been presented for the purposes of illustration and description. It is not intended to be exhaustive or to limit the invention to the precise forms disclosed. Accordingly, many modifications and variations are possible in light of the above teachings. For example, the skew filter 20 may have any size or shape, and include a shaped aperture 38 of any size and shape, which is capable of application to a projection apparatus 10 as described in this specification and which is capable of minimizing the amount of leakage of unwanted polarization. Additionally, the skew filter 20 may be placed at any position in the projection apparatus 10, including between the light source 12 and the first fly's eye integrator lens 14, and between the first fly's eye integrator lens 14 and the second fly's eye integrator lens 16. In yet another embodiment, the shape of the skew filter 20 is controlled by an algorithm that continually measures the constant contrast curve 50 of the light rays 32 emanating from the polarization apparatus 48, determines the optimal shape of the aperture 38, and adjusts the shape of the aperture 38 by manipulating the skew filter 20 accordingly. It is therefore intended that the scope of the invention be limited not by this detailed description.

1. A method of reducing leakage of unwanted polarization in a projection apparatus, comprising:
introducing a light source to the projection apparatus for producing a plurality of light rays, the plurality of light rays including orthogonally-polarized light rays and skew light rays having multiple polarization components; and
preventing the transmission of a substantial portion of the skew light rays to a polarization apparatus by applying a skew filter at a filter position in the projection apparatus, the skew filter including an aperture with a shape configured to allow the orthogonally-polarized rays to pass into the polarization apparatus and to block the skew light rays from entering the polarization apparatus by following a constant contrast curve of a polarizing beam splitter for a cone of light incident on to the polarizing beam splitter.

2. The method of claim 1, wherein the skew light rays include s-polarization components and p-polarization components, and wherein the s-polarization components and the p-polarization components are at least partially incident to an optical plane.

3. The method of claim 1, wherein the polarization apparatus includes the polarizing beam splitter, the polarizing beam splitter having at least one right angle prism having multi-layer filter stacks.

4. The method of claim 1, wherein the polarization apparatus includes a plurality of polarizing beam splitters, each one of the plurality of polarizing beam splitters including at least one right angle prism having multi-layer filter stacks.

5. The method of claim 4, wherein the aperture of the skew filter is cross-shaped.

6. The method of claim 4, wherein the skew filter is substantially square in shape, and wherein the aperture is shaped to allow light rays to pass through substantial portions of the middle of the skew filter.

7. The method of claim 5, further comprising providing a plurality of lenses and at least one UV/IR filter, the plurality of lenses including a first fly's eye integrator lens, a second first fly's eye integrator lens, a first relay lens, and a second relay lens.

8. The method of claim 7, wherein the UV/IR filter is located between the first fly's eye integrator lens and the light source, and wherein the second relay lens is located between the first relay lens and a first polarizing beam splitter in the plurality of polarizing beam splitters.

9. The method of claim 8, wherein the filter position is a position wherein a substantial portion of the skew rays are spatially located.

10. The method of claim 9, wherein the filter position is between the first relay lens and the second relay lens.

11. The method of claim 10, wherein the filter position is located between the second relay lens and a first polarizing beam splitter in the plurality of polarizing beam splitters.

12. The method of claim 1, wherein the projection apparatus is an optical system.

13. The method of claim 12, wherein the plurality of light rays are produced in a conical shape corresponding to an F-number of the optical system.

14. The method of claim 1, wherein the projection apparatus is an image processing system.

15. The method of claim 14, wherein the preventing the transmission of the skew light rays increases a contrast of a resulting image in the image processing system.

16. A method of increasing contrast in an image processing apparatus without increasing the F-number, comprising:
rejecting a substantial portion of a plurality of skew rays introduced by a light source by applying a skew filter at a filter position in the image processing apparatus, the light source introducing a plurality of orthogonally-polarized rays and a plurality of skew rays having multiple polarization components; and
processing the plurality of orthogonal rays in a polarization apparatus, the polarization apparatus including a plurality of polarizing beam filters for transmitting a plurality of orthogonal rays,
wherein the skew filter includes an aperture having a shape configured to follow a constant contrast curve of at least one polarizing beam splitter in the plurality of polarizing beam splitters for a cone of light incident thereto.

17. The method of claim 16, wherein the processing the plurality of orthogonally polarized rays in a polarization apparatus includes providing at least one polarizing beam splitter having at least one right angle prism having multi-layer filter stacks.

18. The method of claim 16, wherein the processing the plurality of orthogonally polarized rays in a polarization apparatus includes providing a plurality of polarizing beam splitters, each one of the plurality of polarizing beam splitters having at least one right angle prism having multi-layer filter stacks.

19. The method of claim 16, wherein the applying a skew filter includes providing an aperture in the skew filter, the aperture of the skew filter having a shape configured to reject a substantial portion of the plurality of skew rays.

20. The method of claim 16, wherein the aperture of the skew filter is substantially cross-shaped.

21. An image projection apparatus comprising:
a light source, the light source producing a plurality of light rays including skew light rays and orthogonally polarized light rays;
a polarization apparatus including at least one polarizing beam splitter;
a plurality of lenses through which the plurality of light rays passes to the polarization apparatus; and
a skew filter positioned at a filter position and having a shaped aperture for blocking the passage of a substantial portion of the skew light rays to the polarization apparatus while allowing a substantial portion of the orthogonally polarized rays to pass through to the polarization apparatus, wherein the shaped aperture of the skew filter has a shape which follows a constant contrast curve of the at least one polarizing beam splitter for a cone of light incident to the at least one polarizing beam splitter.

22. The apparatus of claim 21, wherein the skew light rays include s-polarization components and p-polarization components, and wherein the s-polarization components and the p-polarization components are at least partially incident to an optical plane.

23. The apparatus of claim 21, wherein the at least one polarizing beam splitter includes a right angle prism having multi-layer filter stacks.

24. The apparatus of claim 21, wherein the polarization apparatus includes a plurality of polarizing beam splitters, each one of the polarizing beam splitters including a right angle prism having multi-layer filter stacks.

25. The apparatus of claim 24, further comprising a first fly's eye integrator lens and a second fly's eye integrator lens among the plurality of lenses and an UV/IR filter.

26. The apparatus of claim 25, wherein the UV/IR filter is located between the first fly's eye integrator lens and the light source, and wherein the second relay lens is located between the first relay lens and a first polarizing beam splitter in the plurality of polarizing beam splitters.

27. The apparatus of claim 21, wherein the filter position is a position wherein the substantial portion of the skew rays are spatially located.

28. The apparatus of claim 26, wherein the filter position is between the first relay lens and the second relay lens.

29. The apparatus of claim 26, wherein the filter position is located between the second relay lens and a first polarizing beam splitter in the plurality of polarizing beam splitters.

30. The apparatus of claim 24, wherein the skew filter has an aperture with a shape configured to allow the substantial portion of the orthogonally polarized light rays to pass into the polarization apparatus and to block the substantial portion of the skew light rays from passing into the polarization apparatus.

31. The apparatus of claim 30, wherein the aperture of the skew filter is cross-shaped.

32. The apparatus of claim 30, wherein the skew filter is substantially square in shape, and wherein the aperture is shaped to allow light rays to pass through substantial portions of a middle of the skew filter.

33. The apparatus of claim 21, wherein the image projection apparatus is an optical system.

34. The apparatus of claim 33, wherein the plurality of light rays are produced in a conical shape corresponding to an F-number of the optical system.

35. The apparatus of claim 21, wherein the image projection apparatus is an image processing system.

36. The apparatus of claim 35, wherein the skew filter increases a contrast of a resulting image in the image processing system.

37. A contrast enhancement apparatus in an image projection system, comprising an angular light rejection plate configured to block a substantial portion of angular light from entering a polarization apparatus and to allow orthogonally polarized light to enter the polarization apparatus, the polarization apparatus having at least one polarizing beam splitter, the at least one polarization beam splitter having a right angle prism having multi-layer filter stacks, the polarization apparatus configured to process the orthogonally polarized light to produce an image having enhanced contrast.

38. The apparatus of claim 37, wherein the angular light rejection plate is positioned at a position in the image projection system wherein the substantial portion of the angular light is spatially located.

39. The apparatus of claim 38, wherein the angular light rejection plate includes a shaped aperture.

40. The apparatus of claim 38, wherein the angular light rejection plate includes a cross-shaped aperture.

41. The apparatus of claim 38, wherein the angular light rejection plate is substantially square in shape and includes an aperture therein, the aperture shaped to allow light rays to pass through substantial portions of a middle of the angular light rejection plate.

42. The apparatus of claim 37, wherein the angular light includes s-polarization components and p-polarization components, and wherein the s-polarization components and the p-polarization components are at least partially incident to an optical plane.

43. A method of increasing contrast in an image processing apparatus without increasing the F-number, comprising:
means for introducing a plurality of light rays to a polarization apparatus, the plurality of light rays including skew light rays which enter the polarization apparatus at incident angles and orthogonally polarized light rays which enter the polarization apparatus at orthogonal angles;
means for rejecting a substantial portion of the skew light rays without reducing the F-number of the image processing apparatus; and
means for processing a substantial portion of the orthogonally polarized light rays in the polarization apparatus, the polarization apparatus including a plurality of polarizing beam splitters for transmitting the orthogonally polarized light rays.

44. The method of claim 43, further comprising means for projecting an image.

45. The method of claim 44, wherein the means for projecting an image includes a plurality of micro-displays which project the orthogonally polarized light rays after they pass through the polarization apparatus.

46. The method of claim 43, wherein the means for rejecting further comprises applying a skew filter, the skew filter having an aperture shaped to reject the substantial portion of the skew light rays from entering the polarization apparatus.
